(19) United States
(12) Patent Application Publication
(10) Pub. No.: US 2023/0036083 A1
(43) Pub. Date: Feb. 2, 2023

(54) RECONFIGURABLE ROOF RACK WITH A MULTIFUNCTIONAL SURFACE

(71) Applicant: Overkill Motorsports, Inc., Dallas, TX (US)

(72) Inventor: Travis Kirkman, Dallas, TX (US)

(73) Assignee: Overkill Motorsports, Inc., Dallas, TX (US)

(21) Appl. No.: 17/443,675

(22) Filed: Jul. 27, 2021

(51) Int. Cl. B60R 9/045; B62D 35/00

(52) U.S. Cl. CPC B60R 9/045; B62D 35/00

(57) ABSTRACT

Systems and methods for attaching a reconfigurable roof rack to a vehicle include a rear portion of the reconfigurable roof rack with a multifunctional front surface. The multifunctional front surface has a first function as an airflow guide (e.g., based on non-perpendicular angle the multifunctional front surface forms with the roof) when the reconfigurable roof rack is in a first configuration and a second function as a mounting surface when the reconfigurable roof rack is in a second configuration. The second configuration includes a front portion of the reconfigurable roof rack with a first side and a second side coupled to the multifunctional front surface. The front portion has a slanted front surface which functions as the airflow guide when the reconfigurable roof rack is in the second configuration. The roof of the vehicle can have a removable portion disposed below the front portion of the reconfigurable roof rack.

### BACKGROUND

A typical rack for mounting to a roof of a vehicle uses multiple attachment mechanisms to secure the rack body to the roof of the vehicle. Once secured in place, the rack extends a length of the roof and covers at least a portion of the roof. Racks often extend a full length of the roof, or along as much of the roof as is feasible, to maximize the utility of installing the rack on the roof. Due to the variety of shapes, sizes, and lengths of vehicles, the rack must be selected to correspond to the shape, size, and length of the particular vehicle onto which the rack is installed.

Some vehicles have removable roof panels. If a rack is installed onto this type of vehicle, the entire rack is removed from the roof whenever the roof panels are removed or put in place. This additional process to take off the rack is time consuming, cumbersome, and can discourage vehicle owners from regularly removing the roof panels and using the sun roof. Additionally, a typical rack has a length that is either too long when the roof panel is removed (such that the rack obstructs the opening in the roof) or too short when the roof panel is in place (such that the rack does not extend a full length of usable space on the roof). Purchasing multiple, different racks for the different roof panel configurations increases the costs to the user and requires additional storage space for whichever rack is not being used.

Moreover, installing a rack onto the roof of a vehicle can negatively impact the aerodynamics of the vehicle. The fuel efficiency and the handling capability of the vehicle can decrease when the rack is installed on the roof.

It is with these observations in mind, among others, that various aspects of the present disclosure were conceived and developed.

### SUMMARY

Implementations described and claimed herein address the foregoing problems by providing a reconfigurable roof rack with a multifunctional front surface. For instance, a reconfigurable roof rack for attaching to a vehicle can comprise: a front portion and a rear portion, the rear portion including: one or more roof coupling mechanisms for coupling the rear portion to the vehicle, one or more sides extending along a length dimension of the vehicle, and a multifunctional front surface having: a first function as an air flow guide for the vehicle when the reconfigurable roof rack is in a first configuration, and a second function as a mounting surface for the front portion when the reconfigurable roof rack is in a second configuration.

In some instances, the front portion is a slanted front surface that functions as the air flow guide for the vehicle when the reconfigurable roof rack is in the second configuration. The front portion can be coupled to the rear portion at the multifunctional front surface when the reconfigurable roof rack is in the second configuration; and the front portion can be decoupled from the multifunctional front surface and the vehicle when the reconfigurable roof rack is in the first configuration. Moreover, the multifunctional front surface can be a slanted front surface of the rear portion that performs the first function as the air flow guide when the reconfigurable roof rack is in the first configuration by reducing a drag component of an aerodynamic profile for the vehicle. The multifunctional front surface can be stationary relative to the vehicle when the reconfigurable roof rack is converted between the first configuration and the second configuration. The one or more roof coupling mechanisms can be a first plurality of roof coupling mechanisms, and the front portion can include a second plurality of roof coupling mechanisms including only two roof coupling mechanisms.

In some instances, one or more air flow openings are formed into the one or more sides or a rear surface of the rear portion. Additionally, the one or more sides can be one or more first sides, and the front portion can have one or more second sides with one or more terminating ends for coupling the front portion to the multifunctional front surface when the reconfigurable roof rack is in the second configuration. In some examples, the one or more first sides, the one or more second sides, and the multifunctional front surface are defined by a plurality of planar surfaces. The one or more first sides of the rear portion can align with the one or more second sides of the front portion when the reconfigurable roof rack is in the second configuration. Moreover, the multifunctional front surface can extend perpendicularly relative to the one or more sides.

In some examples, a system for attaching a reconfigurable roof rack to a vehicle comprises: a rear portion and a front portion, the rear portion including: a first roof coupling mechanism for attaching the rear portion to a roof of the vehicle; and a multifunctional front surface that, based on a configuration of the reconfigurable roof rack, functions as an air flow guide for the vehicle or as a mounting surface for the front portion; and the front portion including: a second roof coupling mechanism for attaching the front portion to the roof of the vehicle; and one or more sides for forming a detachable connection with the multifunctional front surface.

In some instances, the rear portion attaches to the roof over an unmovable portion of the roof, and the front portion attaches to the roof over a removable portion of the roof. The multifunctional front surface can be the air flow guide when the configuration is a separated configuration, and a slanted front surface of the front portion can replace the multifunctional front surface as the air flow guide when the configuration is a joined configuration. Moreover, the multifunctional front surface can be the mounting surface for the front portion when the configuration is the joined configuration.

In some examples, a method for attaching a reconfigurable roof rack to a roof of a vehicle includes: coupling a rear portion of the reconfigurable roof rack to the roof of the vehicle with one or more first roof coupling mechanisms, the rear portion including a multifunctional front surface having different functions based on whether the reconfigurable roof rack is in a first configuration or a second configuration; converting the reconfigurable roof rack from the first configuration to the second configuration by: coupling a front portion of the reconfigurable roof rack to the roof of the vehicle with one or more second roof coupling mechanisms, and coupling the front portion to the multifunctional front surface of the rear portion; and converting the reconfigurable roof rack from the second configuration to the first configuration by: decoupling the front portion from the roof of the vehicle, decoupling the front portion from the multifunctional front surface of the rear portion, and removing the front portion from the roof of the vehicle while keeping the rear portion on the roof of the vehicle.

In some instances, the method includes guiding an air flow over the vehicle with the multifunctional front surface when the reconfigurable roof rack is in the first configuration. The method can also include guiding the air flow over the vehicle with a slanted front surface of the front portion when the reconfigurable roof rack is in the second configuration. In some cases, converting the reconfigurable roof rack from the second configuration to the first configuration further includes removing a removable portion of the roof. Converting the reconfigurable roof rack from the first configuration to the second configuration can further include securing a removable portion of the roof over a roof opening.

Other implementations are also described and recited herein. Further, while multiple implementations are disclosed, still other implementations of the presently disclosed technology will become apparent to those skilled in the art from the following detailed description, which shows and describes illustrative implementations of the presently disclosed technology. As will be realized, the presently disclosed technology is capable of modifications in various aspects, all without departing from the spirit and scope of the presently disclosed technology. Accordingly, the drawings and detailed description are to be regarded as illustrative in nature and not limiting.

### BRIEF DESCRIPTION OF THE DRAWINGS

The foregoing summary, as well as the following detailed description, will be better understood when read in conjunction with the appended drawings. For the purpose of illustration, there is shown in the drawings certain embodiments of the disclosed subject matter. It should be understood, however, that the disclosed subject matter is not limited to the precise embodiments and features shown. The accompanying drawings, which are incorporated in and constitute a part of this specification, illustrate an implementation of apparatuses, systems, and methods consistent with the disclosed subject matter and, together with the description, serves to explain advantages and principles consistent with the disclosed subject matter, in which:

FIG. 1A illustrates a front perspective view of an example system including a reconfigurable roof rack which can be converted between a first configuration and a second configuration;

FIG. 1B illustrates a rear perspective view of an example system including a reconfigurable roof rack which can be converted between a first configuration and a second configuration;

FIG. 10 illustrates a top view of an example system including a reconfigurable roof rack which can be converted between a first configuration and a second configuration;

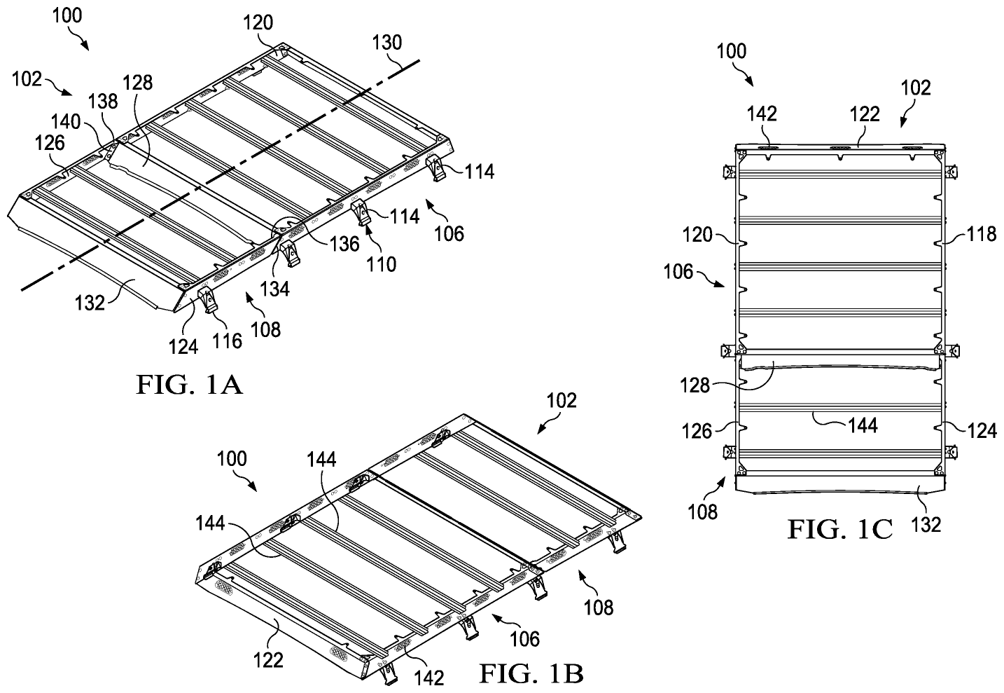

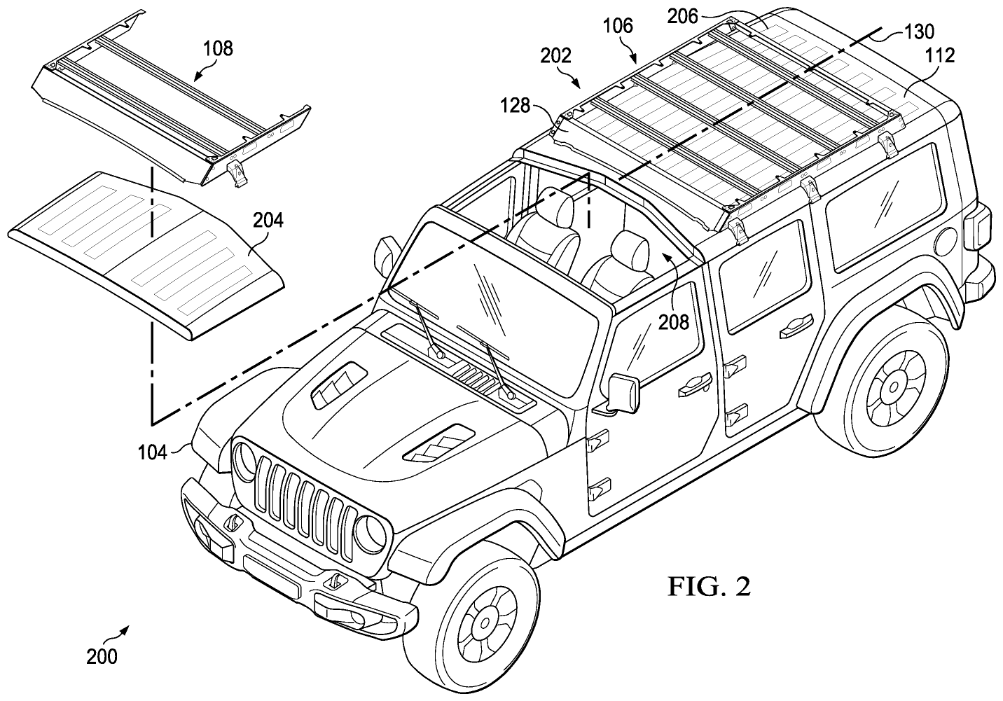

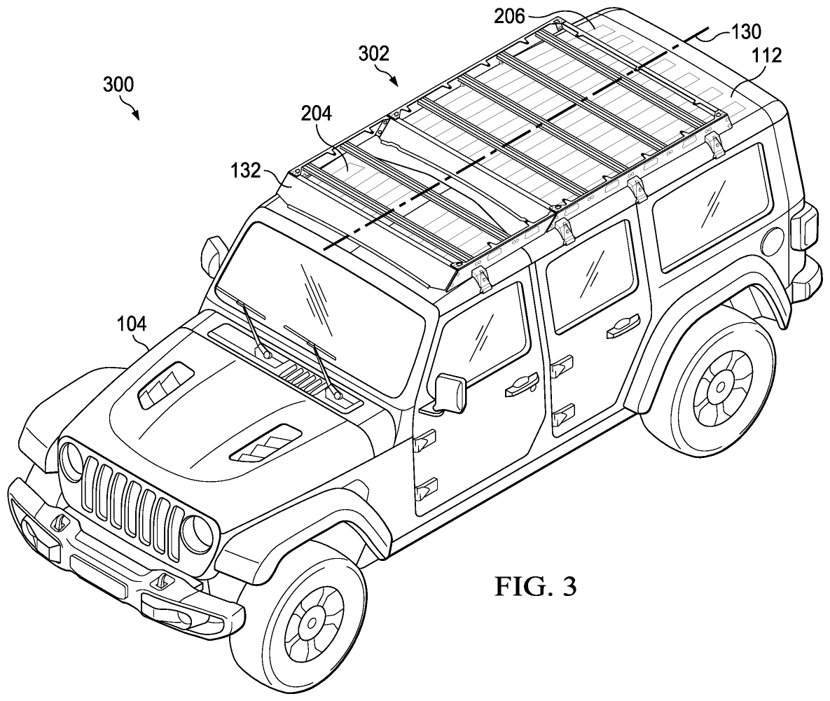

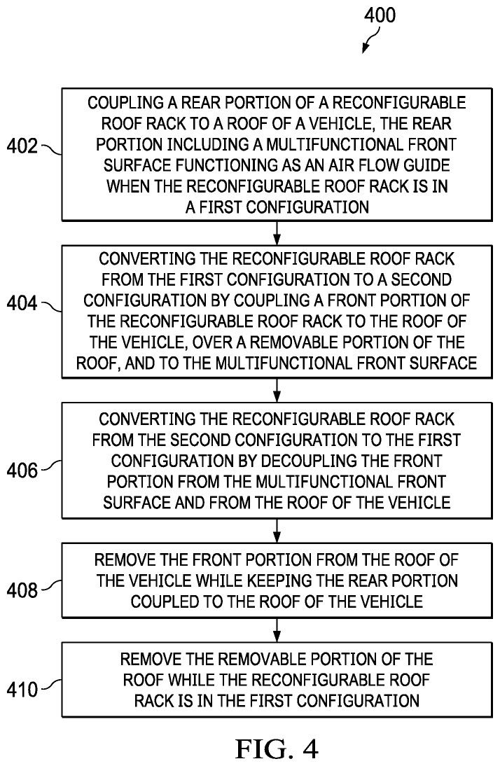

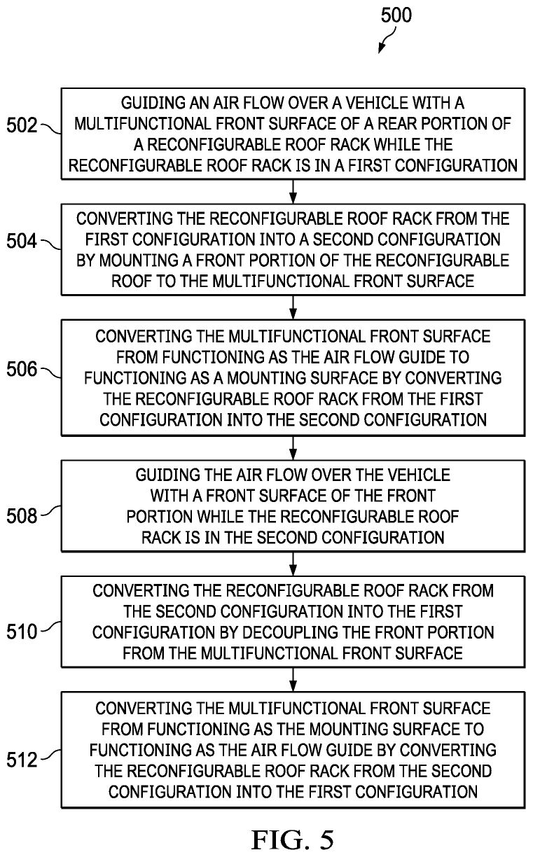

FIG. 2 illustrates an example system including a reconfigurable roof rack in a first configuration of a plurality of configurations, which can form at least a portion of the system of FIGS. 1A-10;

FIG. 3 illustrates an example system including a reconfigurable roof rack in a second configuration of a plurality of configurations, which can form at least a portion of the system of FIGS. 1A-10;

FIG. 4 illustrates example operations of a method for attaching a reconfigurable roof rack to a vehicle, which can be performed by the system of FIGS. 1A-10; and

FIG. 5 illustrates example operations of a method for guiding an airflow over a vehicle with a reconfigurable roof rack, which can be performed by the system of FIGS. 1A-10.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

### I. Terminology

The phraseology and terminology employed herein are for the purpose of description and should not be regarded as limiting. For example, the use of a singular term, such as, “a” is not intended as limiting of the number of items. Also, the use of relational terms such as, but not limited to, “top,” “bottom,” “left,” “right,” “upper,” “lower,” “down,” “up,” and “side,” are used in the description for clarity in specific reference to the figures and are not intended to limit the scope of the presently disclosed technology or the appended claims. Further, it should be understood that any one of the features of the presently disclosed technology may be used separately or in combination with other features. Other systems, methods, features, and advantages of the presently disclosed technology will be, or become, apparent to one with skill in the art upon examination of the figures and the detailed description. It is intended that all such additional systems, methods, features, and advantages be included within this description, be within the scope of the presently disclosed technology, and be protected by the accompanying claims.

Further, as the presently disclosed technology is susceptible to embodiments of many different forms, it is intended that the present disclosure be considered as an example of the principles of the presently disclosed technology and not intended to limit the presently disclosed technology to the specific embodiments shown and described. Any one of the features of the presently disclosed technology may be used separately or in combination with any other feature. References to the terms “embodiment,” “embodiments,” and/or the like in the description mean that the feature and/or features being referred to are included in, at least, one aspect of the description. Separate references to the terms “embodiment,” “embodiments,” and/or the like in the description do not necessarily refer to the same embodiment and are also not mutually exclusive unless so stated and/or except as will be readily apparent to those skilled in the art from the description. For example, a feature, structure, process, step, action, or the like described in one embodiment may also be included in other embodiments, but is not necessarily included. Thus, the presently disclosed technology may include a variety of combinations and/or integrations of the embodiments described herein. Additionally, all aspects of the present disclosure, as described herein, are not essential for its practice. Likewise, other systems, methods, features, and advantages of the presently disclosed technology will be, or become, apparent to one with skill in the art upon examination of the figures and the description. It is intended that all such additional systems, methods, features, and advantages be included within this description, be within the scope of the presently disclosed technology, and be encompassed by the claims.

Any term of degree such as, but not limited to, “substantially,” as used in the description and the appended claims, should be understood to include an exact, or a similar, but not exact configuration. For example, “a substantially planar surface” means having an exact planar surface or a similar, but not exact planar surface. Similarly, the terms “about” or “approximately,” as used in the description and the appended claims, should be understood to include the recited values or a value that is three times greater or one third of the recited values. For example, about 3 mm includes all values from 1 mm to 9 mm, and approximately 50 degrees includes all values from 16.6 degrees to 150 degrees.

The term “coupled” is defined as connected, whether directly or indirectly through intervening components, and is not necessarily limited to physical connections. The connection can be such that the objects are permanently connected or releasably connected. The terms “comprising,” “including” and “having” are used interchangeably in this disclosure. The terms “comprising,” “including” and “having” mean to include, but not necessarily be limited to the things so described. The term “real-time” or “real time” means substantially instantaneously.

Lastly, the terms “or” and “and/or,” as used herein, are to be interpreted as inclusive or meaning any one or any combination. Therefore, “A, B, or C” or “A, B, and/or C” mean any of the following: “A,” “B,” or “C”; “A and B”; “A and C”; “B and C”; “A, B and C.” An exception to this definition will occur only when a combination of elements, functions, steps or acts are in some way inherently mutually exclusive.

### II. General Architecture

Aspects of the present disclosure involve a reconfigurable roof rack for attaching to the roof of a vehicle in multiple, different configurations. The reconfigurable roof rack has multiple, interconnecting components such as a front portion and a rear portion that both adjust a length dimension of the rack and reduce the drag of the vehicle in the different configurations. The rear portion has a multifunctional front surface extending along the front of the rear portion with multiple functions depending on which configuration of the reconfigurable roof rack is deployed. For instance, the reconfigurable roof rack has a first configuration in which the front portion is separated or disconnected from the rear portion (e.g., a separated configuration). That is, in the first configuration, the rear portion is coupled to the roof of the vehicle and the front portion is separated or removed from the roof of the vehicle. The multifunctional front surface functions as an air flow guide when the reconfigurable roof rack is in the first configuration by forming an angle with the roof that reduces drag and improves the aerodynamic profile of the vehicle.

The reconfigurable roof rack is convertible between the first configuration and a second configuration (e.g., a joined configuration) by coupling the front portion to the rear portion. The front portion has two sides with terminating ends that couple or mount to the multifunctional front surface of the rear portion to convert the reconfigurable roof rack from the first configuration to the second configuration. In the second configuration, a front surface of the front portion functions as the air flow guide instead of the multifunctional front surface of the rear portion. The multifunctional front surface functions as a mounting surface for the front portion when the reconfigurable roof rack is in the second configuration.

In some instances, the reconfigurable roof rack can have multiple configurations to correspond to different vehicle shapes, sizes, and roof configurations. For instance, the vehicle can have a removable roof panel in which case the reconfigurable roof rack is mountable to the roof in the second configuration with the front portion disposed over the removable roof panel. Should the user decide to remove the removable roof panel, the front portion of the reconfigurable roof rack can be decoupled from the rear portion and removed from the vehicle while leaving the rear portion in place, converting the reconfigurable roof rack to the first configuration. The front portion can be removed so that the reconfigurable roof rack does not obstruct the opening in the roof. This improves the functionality of the rack by avoiding the need to remove and reattach the entire rack when removing the removable portion. The length of the reconfigurable roof rack is adjustable to match whether the removable portion of the roof is in place or removed. The user does not need multiple different racks for the different roof configurations. The reconfigurable roof rack has the adjustable length because of the multiple configurations, and, as such, can be used with multiple, different types of vehicles of various lengths. Moreover, the reconfigurable roof rack reduces a drag coefficient and improves the aerodynamic profile of the vehicle (which results in improved handling and fuel efficiency) in multiple configurations. Additional benefits will become apparent from the detailed discussion below.

FIGS. 1A-1C illustrate an example system 100 including a reconfigurable roof rack 102 for attaching to a (e.g., vehicle 104 shown in FIGS. 2 and 3). The reconfigurable roof rack 102 can have rear portion 106 to form a detachable connection with a front portion 108, such that the reconfigurable roof rack 102 is reconfigurable between multiple configurations.

In some instances, the reconfigurable roof rack 102 has one or more roof coupling mechanism(s) 110 for coupling the reconfigurable roof rack 102 to a roof of the vehicle 104 (e.g., roof 112 shown in FIGS. 2 and 3). For instance, the rear portion 106 has a first set of roof coupling mechanisms 114 and the front portion 108 has a second set of roof coupling mechanisms 116. The first set of roof coupling mechanism 114 can include an even number of roof coupling mechanism 110, such as two, four, six, eight, ten, etc. roof coupling mechanism 110 (e.g., with matching roof coupling mechanisms 110 on both sides). In some examples, the first set of roof coupling mechanisms 114 includes three roof coupling mechanism 110 at a first side 118 of the rear portion 106 and three roof coupling mechanisms at a second side 120 of the rear portion 106. In some instances, the first set of roof coupling mechanisms 114 includes one or more roof coupling mechanism 110 at a rear surface 122 of the rear portion 106. The second set of roof coupling mechanisms 116 of the front portion 108 can include less roof coupling mechanisms 110 than the first set of roof coupling mechanisms 114. For instance, the second set of roof coupling mechanisms 116 can include only two roof coupling mechanism 110. For instance, a first roof coupling mechanism can be disposed at a first side 124 of the front portion 108 and a second roof coupling mechanism can be disposed at a second side 126 of the front portion 108. Any of the roof coupling mechanisms 110 discussed herein (e.g., the first set of roof coupling mechanisms 114, the second set of roof coupling mechanisms 116, etc.) can include one or more of latches, clamps, friction fits, screws, bolts, detachable bolts, ropes, magnets, adhesives, and the like.

The front portion 108 can include only two roof coupling mechanism 110 yet still be secured in place on the roof 112, for instance, by attaching to a multifunctional front surface 128 of the rear portion 106. The multifunctional front surface 128 can be a substantially planar surface of the rear portion 106 extending between the first side 118 and the second side 120 of the rear portion 106. For instance, the multifunctional front surface 128 can traverse the roof 112 (e.g., extend perpendicularly to a length dimension 130 of the roof 112). The multifunctional front surface 128 is considered “multifunctional” because it can have multiple, different functions for multiple, different configurations of the reconfigurable roof rack 102, as discussed in greater detail below regarding FIGS. 2-5.

For instance, in some configurations (e.g., second configuration 302 in FIG. 3), the multifunctional front surface 128 can function as a coupling surface or mounting surface for the front portion 108. The front portion 108 can have the first side 124 and the second side 126 extending from a front surface 132 of the front portion 108 (e.g., perpendicularly to the front surface 132 and/or parallel to the length dimension 130 of the vehicle 104). The first side 124 has a first terminating end 134 with a first inter-component coupling feature for coupling the front portion 108 to the multifunctional front surface 128. The first inter-component coupling feature can be a first mounting lip 136 extending perpendicularly and inwardly from the first side 124 (e.g., towards a center line of the reconfigurable roof rack 102 that extends parallel to the length dimension 130 of the vehicle 104). Likewise, the second side 126 has a second terminating end 138 with a second inter-component coupling feature for coupling the front portion 108 to the multifunctional front surface 128. The second inter-component coupling feature can be a second mounting lip 140 extending inwardly and perpendicularly from the second side 126. The reconfigurable roof rack 102 can include one or more coupling holes, latches, snap fits, and the like for coupling the first terminating end 134 and the second terminating end 138 to the multifunctional front surface 128 (e.g., by bolting the multifunctional front surface 128 to the first mounting lip 136 and the second mounting lip 140). The first terminating end 134 and the second terminating end 138 can be slanted terminating ends having an angle to abut and be flush with the multifunctional front surface 128. As such, the first side 124 and the second side 126 of the front portion 108 can mate with and/or form a detachable connection (e.g., using the first terminating end 134 and the second terminating end 138) with the multifunctional front surface 128.

In some examples, the reconfigurable roof rack 102 can be formed of a plurality of substantially planar surfaces. For instance, the first side 118, the second side 120, the rear surface 122, and the multifunctional front surface 128 of the rear portion 106 can be formed of substantially planar surfaces. The first side 118 and the second side 120 of the rear portion 106 can be vertical planar surfaces extending substantially perpendicularly from a plane defined by the roof 112. Moreover, bottom edges of the first side 118 and the second side 120 can be substantially parallel to top edges of the first side 118 and the second side 120 and/or can include a slight curve to match a curved surface of the roof 112. The rear surface 122 and/or the multifunctional front surface 128 can be slanted planar surfaces extending from the plane defined by the roof 112 at a non-perpendicular angle. For instance, the multifunctional front surface 128 and/or the rear surface 122 can form an angle with the plane defined by the roof 112 between 20° and 90° (e.g., 30°, 45°, 60°, etc.), such that the multifunctional front surface 128 and/or the rear surface 122 form biased contacts with the roof 112. The multifunctional front surface 128 and/or the rear surface 122 can have bottom edges that are curved edges for forming flush abutments with the roof 112, or the bottom edges can have other, non-straight profiles (e.g., can be non-parallel to top edges of the multifunctional front surface 128 and the rear surface 122) to form the flush abutments with the roof 112. As such, in some configurations, the multifunctional front surface 128 can channel an airflow up and over the reconfigurable roof rack 102 and the vehicle 104 (e.g., when the vehicle 102 is in motion). In other words, the multifunctional front surface can form an airflow guide to reduce drag for the reconfigurable roof rack 102 and the vehicle 104.

In some examples, the first side 124 and the second side 126 of the front portion 108 can be vertical planar surfaces extending substantially perpendicularly from the plane defined by the roof 112. Bottom edges of the first side 124 and the second side 126 of the front portion 108 can be substantially parallel to top edges of the first side 124 and the second side 126 of the front portion 108. The front surface 132 of the front portion 108 can be a slanted front surface such as a slanted planar surface extending from the plane defined by the roof 112 at a non-perpendicular angle. For instance, the front surface 132 of the front portion 108 can form an angle with the plane defined by the roof 112 between 20° and 90° (e.g., 30°, 45°, 60°, etc.), such that the front surface 132 of the front portion 108 forms a biased contact with the roof 112. The front surface 132 of the front portion 108 can have a bottom edge that is a curved edge for forming a flush abutment with the roof 112, or the bottom edge can have other, non-straight profiles (e.g., can be non-parallel to a top edge of the front surface 132) to form the flush abutment with the roof 112. Alternatively, the front surface 132 of the front portion 108 can have a straight, flat bottom edge. In some configurations, the front surface 132 can form the airflow guide to reduce the drag for the reconfigurable roof rack 102 and the vehicle 104, as discussed in greater detail below.

In some examples, the reconfigurable roof rack 102 includes one or more air flow opening(s) 142. The air flow opening(s) 142 can be formed into the first side 118 of the rear portion 106, the second side 120 of the rear portion 106, the first side 124 of the front portion 108 and/or the second side 126 of the front portion 108. The air flow opening(s) 142 can include a cut-out in the surfaces of the reconfigurable roof rack 102. The cut-out can be fully open or can include an openings pattern within the cut-out. The openings pattern can be an array of openings (e.g., such as a honeycomb arrangement of openings) formed by a cut-out insert disposed in the cut-out. The cut-out insert can be formed of a same or similar material as the reconfigurable roof rack 102 (e.g., metal, plastic, carbon-fiber, wood, ceramics, composites or combinations thereof, etc.) or the cut-out insert can be formed of a different material (e.g., mesh cloth). The cut-out insert can be formed integrally with the side surfaces of the reconfigurable roof rack 102 as a single unit during manufacturing, and/or the cut-out insert can be created separately and installed into the cut-out, as part of the manufacturing process, to form the air flow openings 142. The air flow opening(s) 142 can be any shape such as a circle, an elongated circle or ellipse, a triangle, a square, a rectangle, a trapezoid, a polygon, an irregular shape, or combinations thereof. In some instances, the air flow opening(s) 142 improve the reconfigurable roof rack 102 by reducing an amount of material constituting the reconfigurable roof rack 102 (e.g., thus reducing a weight of the reconfigurable roof rack) and/or by reducing a drag component of the reconfigurable roof rack 102 by reducing a surface area of the side surfaces.

In some examples, the reconfigurable roof rack 102 includes one or more cross bar(s) 144. The cross bar(s) 144 can extend transversely across the reconfigurable roof rack 102 (e.g., perpendicular to the length dimension 130 of the vehicle 104). In some instances, the cross bar(s) 144 extend between a first inner surface of the first side 118 of the rear portion 106 and a second inner surface of the second side 120 of the rear portion 106. Likewise, the cross bar(s) 144 can extend between a third inner surface of the first side 124 of the front portion 108 and a fourth inner surface of the second side 126 of the front portion 108. The cross bar(s) 144 can form one or more mounting bodies for attaching items (e.g., sporting goods, storage containers, furniture, beds, refrigerators, other goods, and the like) to the reconfigurable roof rack 102. Moreover, the cross bar(s) 144 can provide lateral structural support for the reconfigurable roof rack 102. For instance, the cross bar(s) 144 can be bars, tubes, beams, blocks, and the like. The cross bar(s) 144 can be formed of a rigid material (e.g., plastic, metal, carbon fiber, composites thereof, etc.) or another type of material, such as a bungee-cord type material or a strap.

FIGS. 2 and 3 illustrate the reconfigurable roof rack 102 in different configurations. FIG. 2 illustrates an example system 200 including the reconfigurable roof rack 102 in a first configuration 202. The first configuration 202 can be a separated configuration with the front portion 108 separated and/or removed from the rear portion 106. FIG. 3 illustrates an example system 300 including the reconfigurable roof rack 102 in a second configuration 302. The second configuration 302 can be a joined configuration with the front portion 108 coupled to the rear portion 106 at the multifunctional front surface 128. The first configuration 202, the second configuration 302, and techniques for converting the reconfigurable roof rack 102 between the first configuration 202 and the second configuration 302 are discussed in greater detail below.

Turning to FIG. 2, the system 200 includes the reconfigurable roof rack 102 in the first configuration 202 with the front portion 108 separated or removed from the rear portion 106. For instance, the reconfigurable roof rack 102 can be converted from the second configuration 302 (or another configuration) into the first configuration 202 by decoupling the front portion 108 from the rear portion 106 (e.g., by actuating or removing a portion of the first inter-component coupling feature and the second inter-component coupling feature at the multifunctional front surface 128). In the first configuration 202, the multifunctional front surface 128 can have a first function as the air flow guide for the reconfigurable roof rack 102 and the vehicle 104. For instance, in the first configuration 202, the multifunctional front surface 128 can be the surface of the reconfigurable roof rack 102 closest to a front of the vehicle 104, and can be exposed to a headwind of the vehicle 104 when the vehicle 104 is in motion. The non-perpendicular angle formed by the multifunctional front surface 128 and the roof 112, along with the planar, flat surface of the multifunctional front surface 128, can direct, channel, or guide the air flow over the reconfigurable roof rack 102 and/or the vehicle 104, and can reduce a turbulence of a boundary layer of the air flow. As such, in the first configuration 202, the multifunctional front surface 128 can function as the air flow guide and can reduce a drag coefficient of an aerodynamic profile of the vehicle 104 and/or the reconfigurable roof rack 102.

In some examples, converting the reconfigurable roof rack 102 into the first configuration 202 (e.g., from the second configuration 302) can include removing a removable portion 204 of the roof 112. The removable portion 204 can be a removable roof panel or section, sun roof, a convertible portion of the roof 112, a retractable portion of the roof 112, a modular portion of the roof 112, or any other non-static portion of the roof 112. The removable portion 204 can be a removable portion of a T-Top roof 112 or a Jeep® Freedom Top® roof 112. The rear portion 106 can be positioned above an unmovable, static, stationary, or non-removable portion 206 of the roof 112 and next to or behind the removable portion 204 (e.g., closer to the rear of the vehicle 104 along the length dimension 130). The removable portion 204 can be a removable roof panel and, in the first configuration 202, the removable portion 204 can be removed or omitted from the roof 112 to form a roof opening 208 (e.g., a sun roof opening). The roof opening 208 and/or the removable portion 204 can be in front of the rear portion 106 (e.g., closer to a front of the vehicle 104 along the length dimension 130) and/or in front of the reconfigurable roof rack 102 in the first configuration 202. In some instances, the rear portion 106 is coupled to the roof 112 over the non-removable portion 206 of the roof 112 and is stationary or static with respect to the vehicle 104 as the reconfigurable roof rack 102 is converted from the second configuration 302 to the first configuration 202 and/or from the first configuration 202 to the second configuration 302.

Turning to FIG. 3, the system 300 can include the reconfigurable roof rack 102 in the second configuration 302 with the front portion 108 coupled to or joined with the rear portion 106. In other words, the second configuration 302 can be the joined configuration. For instance, the reconfigurable roof rack 102 can be converted from the first configuration 202 (or another configuration) into the second configuration 302 by coupling the front portion 108 to the rear portion 106 so that the front portion 108 is fixed (e.g., removably coupled) to the rear portion 106). In the second configuration 302, the front portion 108 and the rear portion 106 form a single unit. As such, in the second configuration 302, the multifunctional front surface 128 has the second function as the mounting surface for the front portion 108. For instance, the first terminating end 134 and the second terminating end 138 of the front portion 108 can mate, couple, mount, and/or attach to the multifunctional front surface 128 in the second configuration 302.

In some examples, the front surface 132 of the front portion 108 is a slanted front surface that functions as the air flow guide for the vehicle 104 and/or the reconfigurable roof rack 102 when the reconfigurable roof rack 102 is in the second configuration 302. For instance, in the second configuration 302, the front surface 132 of the front portion 108 can be the surface of the reconfigurable roof rack 102 closest to the front of the vehicle 104, and can be exposed to the headwind of the vehicle 104 when the vehicle 104 is in motion. The non-perpendicular angle formed by the front surface 132 of the front portion 108 and the roof 112, along with the planar, flat surface of the front surface 132, can direct, channel or guide the air flow over the reconfigurable roof rack 102 and/or the vehicle 104, for instance, reducing the turbulence of the boundary layer of the air flow. As such, in the second configuration 302, the front surface 132 of the front portion 108 can function as the air flow guide and can reduce a drag coefficient of an aerodynamic profile of the vehicle 104 and/or the reconfigurable roof rack 102. In other words, the front surface 132 of the front portion 108 can replace the multifunctional front surface 128 of the rear portion 106 as the air flow guide when the reconfigurable roof rack 102 is in (e.g., converted into) the second configuration 302.

In some examples, the reconfigurable roof rack 102 has a greater length in the second configuration 302, with the front portion 108 coupled to the rear portion 106, than in the first configuration 202, with the front portion 108 separated from the rear portion 106. The modular characteristics of the reconfigurable roof rack 102 cause the reconfigurable roof rack 102 to have an adjustable length dimension. For instance, the front portion 108 can be positioned over the removable portion 204 of the roof in the second configuration 302. For instance, in the second configuration the removable portion 204 can be attached to the vehicle positioned to cover the roof opening 208, and the front portion 108 can be secured to the roof 112 over the removable portion 204 (e.g., in addition to coupling to the rear portion 106 at the multifunctional front surface 128).

In some examples, the rear portion 106 and the front portion 108 of the reconfigurable roof rack 102 can form a united, stationary body or unit relative to the vehicle 104 when the reconfigurable roof rack 102 is in the second configuration 302. In the second configuration 302, the first side 118 of the rear portion 106 can substantially align with the first side 124 of the front portion 108 to form a first continuous planar side of the reconfigurable roof rack 102, extending from the front surface 132 of the front portion 108 to the rear surface 122 of the rear portion 106. Additionally, in the second configuration 302, the second side 120 of the rear portion 106 can substantially align with the second side 126 of the front portion 108 to form a second continuous planar side of the reconfigurable roof rack 102. The second continuous planar side can extend between the front surface 132 of the front portion 108 to the rear surface 122 of the rear portion 106, and can be parallel to the first continuous planar side.

In some examples, the reconfigurable roof rack 102 can be converted between the first configuration 202 and the second configuration 302. The reconfigurable roof rack 102 can be configured, reconfigured, converted, and/or transitioned multiple times from the first configuration 202 to the second configuration 302 and/or from the second configuration 302 to the first configuration 202. The rear portion 106 (e.g., and the multifunctional front surface 128 of the rear portion 106) can remain fixed to the vehicle 104 and/or be stationary relative to vehicle 104 when the reconfigurable roof rack 102 is converted from first configuration 202 to the second configuration 302 and/or from the second configuration 302 to the first configuration 202. In some instances, converting the reconfigurable roof rack 102 from the second configuration 302 to the first configuration 202 includes removing the removable portion 204 of the roof 112. Likewise, converting the reconfigurable roof rack 102 from the first configuration 202 to the second configuration 302 can include securing the removable portion 204 of the roof 112 over the roof opening 208.

In some examples, the reconfigurable roof rack 102 can include multiple portions in addition to the rear portion 106 and the front portion 108. The reconfigurable roof rack 102 can include one or more removable intermediate portions that interconnect between the rear portion 106 and the front portion 108 (e.g., using similar or identical techniques discussed above for coupling the front portion 108 to the rear portion 106). Any of the removable intermediate portions can also include an additional multifunctional front surface 128. Moreover, the reconfigurable roof rack 102 can include removable side extensions that removably couple to the first side 118 of the rear portion 106, the second side 120 of the rear portion 106, the first side 124 of the front portion 108, and/or the second side 126 of the front portion 108. As such, the reconfigurable roof rack 102 can include multiple modular components for adjusting or extending a length dimension and/or a width dimension of the reconfigurable roof rack 102 (e.g., to correspond to a configuration, size, or shape of the roof 112 of the vehicle 104) using the techniques discussed herein.

Although the reconfigurable roof rack 102 is discussed herein as being formed of a plurality of planar surfaces, other structural components can form the reconfigurable roof rack 102 as well. For instance, any of the first side 118, the second side 120, or the rear surface 122 of the rear portion 106, and/or the first side 124 or the second side 126 of the front portion 108 can be formed at least partially of bars, beams, ropes, straps, tubes, blocks, other structural bodies, and the like (e.g., additionally or alternatively to being formed of planar surfaces).

In some examples, the reconfigurable roof rack 102 (e.g., the rear portion 106 of the reconfigurable roof rack 102) is coupled to the roof 112 of the vehicle in the first configuration 202 and/or the second configuration 302. Alternatively, the reconfigurable roof rack 102 can be separated, removed, and/or decoupled from the vehicle 104 in the first configuration 202, in the second configuration 302, and/or while being converted between the first configuration 202 and the second configuration 302. Moreover, the rear portion 106 can remain fixed or coupled to the roof 112 of the vehicle 104 while the front portion 108 is being removed from the roof 112 of the vehicle 104. The front portion 108 of the reconfigurable roof rack 102 can be coupled to the roof 112 in the second configuration 302 and/or decoupled from the roof 112 in the second configuration 302 and the first configuration 202.

FIG. 4 illustrates an example method 400 for attaching the reconfigurable roof rack 102 to the roof 112 of the vehicle 104, which can be performed by any of the systems 100-300 discussed herein. At operation 402, the method 400 couples the rear portion 106 of the reconfigurable roof rack 102 to the roof 112 of the vehicle 104, the rear portion 106 including the multifunctional front surface 128 functioning as an air flow guide when the reconfigurable roof rack 102 is in the first configuration 202. At operation 404, the method 400 converts the reconfigurable roof rack 102 from the first configuration 202 to the second configuration 302 by coupling the front portion 108 of the reconfigurable roof rack 102 to the vehicle 104, over the removable portion 204 of the roof 112, and to the multifunctional front surface 128. At operation 406, the method 400 converts the reconfigurable roof rack 102 from the second configuration 302 to the first configuration 202 by decoupling the front portion 108 from the multifunctional front surface 128 and from the roof 112 of the vehicle 104. At operation 408, the method 400 removes the front portion 108 from the roof 112 of the vehicle 104 while keeping the rear portion 106 coupled to the roof 112 of the vehicle 104. At operation 410, the method 400 removes the removable portion 204 of the roof 112 while the reconfigurable roof rack 102 is in the first configuration 202.

FIG. 5 illustrates an example method 500 for guiding an air flow over the vehicle 104 with the reconfigurable roof rack 102, which can be performed by any of the systems 100-300 discussed herein. At operation 502, the method 500 guides an air flow over the vehicle 104 with the multifunctional front surface 128 of the rear portion 106 of the reconfigurable roof rack 102. At operation 504, the method 500 converts the reconfigurable roof rack 102 from the first configuration 202 into the second configuration 302 by mounting the front portion 108 to the multifunctional front surface 128. At operation 506, the method 500 converts the multifunctional front surface 128 from functioning as the air flow guide to functioning as a mounting surface (e.g., for the front portion 108) by converting the reconfigurable roof rack 102 from the first configuration 202 into the second configuration 302. At operation 508, the method 500 guides the air flow over the vehicle 104 with the front surface of the front portion while the reconfigurable roof rack 102 is in the second configuration 302. At operation 510, the method 500 converts the reconfigurable roof rack 102 from the second configuration 302 into the first configuration 202 by decoupling the front portion 108 from the multifunctional front surface 128. At operation 512, the method 500 converts the multifunctional front surface 128 from functioning as the mounting surface to functioning as the air flow guide by converting the reconfigurable roof rack 102 from the second configuration 302 into the first configuration 202.

It is to be understood that the specific order or hierarchy of steps in the methods depicted in FIGS. 4 and 5 are instances of example approaches and can be rearranged while remaining within the disclosed subject matter. For instance, any of the steps depicted in FIGS. 4 and 5 may be omitted, repeated, performed in parallel, performed in a different order, and/or combined with any other of the steps depicted in FIGS. 4 and 5.

While the present disclosure has been described with reference to various implementations, it will be understood that these implementations are illustrative and that the scope of the present disclosure is not limited to them. Many variations, modifications, additions, and improvements are possible. More generally, implementations in accordance with the present disclosure have been described in the context of particular implementations. Functionality may be separated or combined differently in various implementations of the disclosure or described with different terminology. These and other variations, modifications, additions, and improvements may fall within the scope of the disclosure as defined in the claims that follow.

1. A reconfigurable roof rack for attaching to a vehicle, the reconfigurable roof rack comprising:
a front portion and a rear portion, the rear portion including:
one or more roof coupling mechanisms for coupling the rear portion to the vehicle,
one or more sides extending along a length dimension of the vehicle, and
a multifunctional front surface having:
a first function as an air flow guide for the vehicle when the reconfigurable roof rack is in a first configuration, and
a second function as a mounting surface for the front portion when the reconfigurable roof rack is in a second configuration.

2. The reconfigurable roof rack of claim 1,
wherein,
the front portion includes a slanted front surface that functions as the air flow guide for the vehicle when the reconfigurable roof rack is in the second configuration.

3. The reconfigurable roof rack of claim 1,
wherein,
the front portion is coupled to the rear portion at the multifunctional front surface when the reconfigurable roof rack is in the second configuration; and
the front portion is decoupled from the multifunctional front surface and the vehicle when the reconfigurable roof rack is in the first configuration.

4. The reconfigurable roof rack of claim 1,
wherein,
the multifunctional front surface is a slanted front surface of the rear portion that performs the first function as the air flow guide when the reconfigurable roof rack is in the first configuration by reducing a drag component of an aerodynamic profile for the vehicle.

5. The reconfigurable roof rack of claim 1,
wherein,
the multifunctional front surface is stationary relative to the vehicle when the reconfigurable roof rack is converted between the first configuration and the second configuration.

6. The reconfigurable roof rack of claim 1,
wherein,
the one or more roof coupling mechanisms are a first plurality of roof coupling mechanisms, and the front portion includes a second plurality of roof coupling mechanisms including only two roof coupling mechanisms.

7. The reconfigurable roof rack of claim 1, further comprising:
one or more air flow openings formed into the one or more sides or a rear surface of the rear portion.

8. The reconfigurable roof rack of claim 1,
wherein,
the one or more sides are one or more first sides, and the front portion has one or more second sides with one or more terminating ends for coupling the front portion to the multifunctional front surface when the reconfigurable roof rack is in the second configuration.

9. The reconfigurable roof rack of claim 8,
wherein,
the one or more first sides, the one or more second sides, and the multifunctional front surface are defined by a plurality of planar surfaces.

10. The reconfigurable roof rack of claim 8,
wherein,
the one or more first sides of the rear portion align with the one or more second sides of the front portion when the reconfigurable roof rack is in the second configuration.

11. The reconfigurable roof rack of claim 1,
wherein,
the multifunctional front surface extends perpendicularly relative to the one or more sides.

12. A system for attaching a reconfigurable roof rack to a vehicle, the system comprising:
a rear portion and a front portion, the rear portion including:
a first roof coupling mechanism for attaching the rear portion to a roof of the vehicle; and
a multifunctional front surface that, based on a configuration of the reconfigurable roof rack, functions as an air flow guide for the vehicle or as a mounting surface for the front portion; and
the front portion including:
a second roof coupling mechanism for attaching the front portion to the roof of the vehicle; and
one or more sides for forming a detachable connection with the multifunctional front surface.

13. The system of claim 12,
wherein,
the rear portion attaches to the roof over an unmovable portion of the roof, and
the front portion attaches to the roof over a removable portion of the roof.

14. The system of claim 12,
wherein,
the multifunctional front surface is the air flow guide when the configuration is a separated configuration, and
a slanted front surface of the front portion replaces the multifunctional front surface as the air flow guide when the configuration is a joined configuration.

15. The system of claim 14,
wherein,
the multifunctional front surface is the mounting surface for the front portion when the configuration is the joined configuration.

16. A method for attaching a reconfigurable roof rack to a roof of a vehicle, the method including:
coupling a rear portion of the reconfigurable roof rack to the roof of the vehicle with one or more first roof coupling mechanisms, the rear portion including a multifunctional front surface having different functions based on whether the reconfigurable roof rack is in a first configuration or a second configuration;
converting the reconfigurable roof rack from the first configuration to the second configuration by:
coupling a front portion of the reconfigurable roof rack to the roof of the vehicle with one or more second roof coupling mechanisms, and
coupling the front portion to the multifunctional front surface of the rear portion; and
converting the reconfigurable roof rack from the second configuration to the first configuration by:
decoupling the front portion from the roof of the vehicle,
decoupling the front portion from the multifunctional front surface of the rear portion, and
removing the front portion from the roof of the vehicle while keeping the rear portion on the roof of the vehicle.

17. The method of claim 16, further comprising:
guiding an air flow over the vehicle with the multifunctional front surface when the reconfigurable roof rack is in the first configuration.

18. The method of claim 17, further comprising:
guiding the air flow over the vehicle with a slanted front surface of the front portion when the reconfigurable roof rack is in the second configuration.

19. The method of claim 16,
wherein,
converting the reconfigurable roof rack from the second configuration to the first configuration further includes removing a removable portion of the roof.

20. The method of claim 16,
wherein,
converting the reconfigurable roof rack from the first configuration to the second configuration further includes securing a removable portion of the roof over a roof opening.
